(19) United States
(12) Patent Application Publication
(10) Pub. No.: US 2025/0361097 A1
(43) Pub. Date: Nov. 27, 2025

(54) Conveyor device, operating method and use

(71) Applicant: Deutsche Post AG, Bonn (DE)

(72) Inventors: Viktor Kuznecov, Siegburg (DE); Frank Fisser, Köln (DE)

(21) Appl. No.: 19/213,012

(22) Filed: May 20, 2025

(30) Foreign Application Priority Data
May 22, 2024 (DE) 10 2024 114 335.5
Aug. 26, 2024 (EP) 24196544.1

(51) Int. Cl. B65G 45/26; B25J 11/00; B65G 43/02

(52) U.S. Cl. CPC B65G 45/26; B25J 11/0085; B65G 43/02

(57) ABSTRACT

A conveyor device for conveying objects includes a circulating conveyor line, along which a multiplicity of conveyor apparatuses and a maintenance apparatus are movably guided in a row, wherein the conveyor apparatuses are each designed to unload an object resting thereon transversely with respect to the conveyor line, and the maintenance apparatus includes a sensor system for detecting the conveyor line in order to obtain information relating to an upper side and/or an underside of the conveyor line.

The present application is based upon and claims the right of priority to DE Patent Application No. 10 2024 114 335.5, filed May 22, 2024, and EP Application Serial No. 24196544.1, filed Aug. 26, 2024, the disclosure of which is hereby incorporated by reference herein in its entirety for all purposes.

The invention relates to a conveyor device for conveying objects. The invention further relates to a method for operating a conveyor device for conveying objects and to a use.

It is known that conveyed objects can jam in a conveyor device or be lost. This firstly endangers the conveyor device itself or its proper operation. Secondly, the proper transport of the objects is endangered.

Furthermore, conveyor devices have to be maintained regularly and possibly repaired. To this end, a conveyor device must be switched off regularly, complicated manual activities have to be completed and attention must be paid to proper occupational safety.

On this basis, the object of the invention is to provide solutions with which the conveyance or the transport of objects in conveyor devices is more successful. In particular, maintenance and repair in conveyor devices is to be improved. In particular, disadvantages in solutions known from the prior art are to be avoided or else at least substantially reduced.

This object is achieved by the subject matter of the independent patent claims. In particular, the invention is defined in the independent patent claim. Preferred developments of the invention will be found in the subordinate claims, in the figures and in the following description.

The invention in conjunction with conveyor apparatuses can be used to reduce failure times. Occupational safety during maintenance and repair and the durability of the conveyor apparatuses can likewise be improved. The invention possibly contributes to the conveyor device being able to be operated at higher speed or conveying speed, since it is possible to react more quickly to problems. The refinements of the invention can further improve the aforementioned advantages.

Proposed in particular is a conveyor apparatus for conveying objects, having a circulating conveyor line with one or more movable conveying apparatuses for the support of the objects. The conveying apparatus can be guided movably along the conveyor line. A multiplicity of conveying apparatuses and a maintenance apparatus for detecting the conveyor line can be movably guided in a row along the conveyor line. In particular, the conveyor apparatus has a/the maintenance apparatus for detecting the conveyor line, or a plurality thereof. In particular, the conveyor apparatuses are each designed to unload an object, which is resting or conveyed thereon, transversely with respect to the conveyor line. In particular, the conveyor device has a detection apparatus permanently installed on the conveyor line for detecting the conveyor apparatus and/or an object. The maintenance apparatus has, in particular, a sensor system for detecting the conveyor line to obtain information relating to an upper side and/or an underside of the conveyor line. The maintenance apparatus has, in particular, an actuator apparatus for carrying out maintenance work on the conveyor line.

For example, with the independent patent claim directed to the conveyor device, a cross-belt conveyor or cross-belt sorter or tipping bowl sorter having a multiplicity of conveying cells is proposed, wherein one of the conveying cells is replaced by a maintenance cell or maintenance unit, which has sensors for inspecting the conveyor line or sorting line. Using the maintenance cell, an inspection can thus be made in a simplified manner, even at hard-to-access points in the conveyor or sorter.

Proposed in particular is a method for operating a/the conveyor device, the method comprising: moving the maintenance apparatus(es) and preferably the conveyor apparatus(es) along the conveyor line, and detecting the conveyor line by means of the maintenance apparatus to obtain the information, and in particular comparing the information obtained with previously known information about the conveyor line in order to check the function and/or alignment of the detection apparatus and/or to localize a geometric deviation in the conveyor line.

For example, with the independent patent claim directed to the method, an operating method of a cross-belt sorter or cross-belt conveyor having a multiplicity of conveying cells is proposed, wherein one of the conveying cells is replaced by a maintenance cell or maintenance unit, which has sensors for inspecting the conveyor line or sorting line. In the method, conveying cells and maintenance cell are moved together or at the same speed, including a standstill, while the maintenance cell inspects the conveyor line or sorting line or detects it using sensors. Thus, helpful information relating to the condition can be obtained in particular during normal operation of the cross-belt sorter, which can be used to improve the maintenance.

Proposed in particular is a use of a, for example remotely controllable, maintenance apparatus
having a sensor system for detecting a conveyor line of a conveyor device designed to convey objects to obtain information relating to an upper side and/or an underside of the conveyor line and/or to further side areas or side structures of the conveyor line, and/or
having a sensor system for detecting a conveyor line of a conveyor device designed to convey objects to localize a geometric deviation in the conveyor line, and/or
having a sensor system for detecting a conveyor line of a conveyor device designed to convey objects to check the function and/or alignment of a detection apparatus which is permanently installed on the conveyor line and is designed to detect the conveyor apparatus and/or an object, and/or
having an actuator apparatus for carrying out maintenance work of a conveyor line of a conveyor device designed to convey objects.

The use provides in particular operation of the conveyor device moving the conveyor line and the maintenance apparatus at the same speed. The conveyor device can in particular have conveyor apparatuses that are lined up in a row and can each be designed to unload an object resting thereon transversely with respect to the conveyor line.

For example, with the independent patent claim directed to the use, the application of a maintenance cell in a cross-belt sorter or tipping bowl sorter, which replaces a conveying cell, is proposed, wherein the maintenance cell has sensors for inspecting the conveyor line of the cross-belt sorter. The maintenance cell and the conveying cells are moved or operated jointly or at the same speed, including a standstill.

The conveyor device typically refers to an installation which is provided to transport objects from one location to another and/or distribute them between locations. The conveyor device is regularly automated, which in particular includes control via computer systems. The conveyor device can, for example, comprise belts, rolls, rails, drives and/or other technical means in order to convey the objects. For example, the conveyor device can have a moved conveyor belt, in particular wherein the conveyor belt is to be understood as a conveying apparatus.

The conveyor device is in particular arranged or provided in a production installation, post distribution center, letter distribution center and/or other logistical and/or producing apparatuses. In particular, the conveyor device can be provided in a storage or production hall, for example for conveying objects as stored goods and/or production goods.

“Objects” can be mail or any desired transport goods or objects which can be moved on a conveyor line. For example, the objects can be pieces of luggage, cases, cans, bottles, goods, commercial goods, a material stream, bulk goods or the like.

Objects, in particular as mail, can be dimensionally stable and/or not dimensionally stable and/or comprise packages, parcels, letters, letter mail, palleted goods and the like. Not dimensionally stable objects are, for example, bags, in particular made of plastic and/or cellulose-based material. The object regularly relates to packaged or unpackaged objects and/or documents. The object is in particular provided for transport or distribution by means of the conveyor device. Objects can be of different sizes and heavy or of another nature. The object can comprise: envelope, document envelope, letter envelope, padded envelope, packaging material, carton and/or pallet. Typically, the object weighs at least one gram. The object can weigh a plurality of kilograms, for example 10, 20, 30, 50 or more kilograms. The object can have a size in a direction between one or more millimeters to one or more centimeters, decimeters or meters. The packaging of the object can be directed to protect the content of the object against damage during transport or distribution. The object or its packaging can be padded and/or mechanically reinforced. The object can be wrapped with adhesive tape or packaging tape. It has been recognized that poorly or unfavorably packaged objects, for example with projecting packaging material, adhesive tape or other projections, or else narrow objects, can jam in the conveyor device. Here, the invention having the maintenance device can help.

It is possible that the object is equipped with a location system in order to monitor and/or to control its movement during the conveyance, in particular in the conveyor device. However, there is often no location system, for which reason the present invention with the maintenance device will provide a remedy. To this extent, the maintenance device may have a location system.

The circulating conveyor line relates in particular to part of the conveyor device which is able to move the objects in a continuous circuit and/or along a defined section. This conveyor line can have a conveyor belt or belt, a chain and/or a rail configuration, which optionally makes it possible for the objects to return again to the starting point. For example, the conveyor line can be designed with a view to adjustability of a speed or conveyor speed and/or integration of sorting and processing stations along the conveyor line. It is possible that stations, for example automated loading stations and/or unloading stations, are integrated or linked in order to increase functionality. The conveyor line regularly has an/the upper side and an/the underside. The upper side and the underside are in particular sides facing away from each other, for example wherein the conveying apparatus separates the upper side and underside from each other. The upper side can be referred to as a first side and the underside as a second side. The objects are typically located on the upper side or first side.

The conveyor apparatus is a part of the conveyor device that is movable, is to be moved and/or is provided to move objects. Typically, the conveyor device has one or more drives which can move the conveyor apparatus(es). A plurality of drives can be arranged distributed along the conveyor line. The conveyor apparatus can be moved in a conveying direction or main transport direction and/or be designed to move objects in this direction. The conveying direction can run in a straight line and/or in a curve at least in some sections. For example, the conveying direction forms a circumferentially closed or at least substantially endless, in particular annular, circuit. The conveying direction can extend between ends and/or be branched. An annular circuit with branching can also be provided.

The conveyor apparatus can be understood as a conveying means of the conveyor line, in particular which is intended to be in contact with objects lying or resting thereon. The conveyor line can be designed as a conveyor belt or have the latter. To this extent, the conveyor apparatus can be a conveyor belt with a support for one or more objects and possibly for the maintenance apparatus. The conveyor apparatus is in particular configured to transport one or more objects. It is possible for a plurality of conveyor belts to be provided. The conveyor line can be designed as a roller conveyor or have the latter. To this extent, the conveyor apparatus can be designed as a driven and/or freely rotating roller for moving objects, wherein, in this case, in particular, a plurality of rollers are provided.

It is possible for one or the multiplicity of conveyor apparatuses to be provided. The conveyor apparatus can be one of many modular conveying elements of the conveyor device, wherein each conveying element can be provided to convey individual objects. The multiplicity of conveyor apparatuses or conveying elements can be lined up in a row along the conveyor line or conveying direction and coupled to one another, in particular pivotably. The conveyor apparatuses can to this extent form a circulating or coherent chain. The conveyor apparatuses can then be moved jointly and at the same speed. The maintenance apparatus can be surrounded along the conveying direction from the front and back by respectively one conveyor apparatuses and in particular coupled to the latter, in particular in a similar or the same way as conveyor apparatuses to one another. The conveyor apparatus and/or the maintenance apparatus can be rail-guided. The conveyor line can have a rail for the conveyor apparatus(es) and, if appropriate, the maintenance apparatus(es).

The maintenance apparatus relates, for example, to a system or a device which is provided to monitor or to diagnose and/or to support in the process the state and the serviceability of the conveyor line. The maintenance apparatus can include sensors, cameras and/or other instruments which can detect information about the state of the conveyor line. The maintenance apparatus can be remotely controllable, which can mean in particular at least a transmission of the information away from the maintenance apparatus to a computer device, for example to a remote control, and optionally operation of the maintenance apparatus from a distance. The maintenance apparatus can be designed to transmit the information. The information can be analyzed in particular on the maintenance apparatus itself and/or in another location, for example in order to plan maintenance work and/or to identify problems before they lead to disruptions. The maintenance apparatus can comprise software tools which are configured to visualize the information and/or can give recommendations for maintenance intervals and repairs. The maintenance apparatus can be battery-operated and/or fed with electricity along the conveyor line or by the conveyor line. The maintenance apparatus can have a power generator which draws its energy from the movement of the maintenance apparatus along the conveyor line. For example, the power generator can be driven mechanically by the movement of the maintenance apparatus in order that electricity is available to the maintenance apparatus. The maintenance apparatus can be understood as an unmanned vehicle and/or object, in particular which can move along the conveyor line, preferably with the conveyor apparatus or the conveyor apparatuses, in particular at the same speed. The maintenance apparatus can have its own drive and/or be driven by the conveyor line.

If the conveyor apparatus is designed for unloading an object resting or conveyed thereon transversely with respect to the conveying line, it is possible to speak of a cross-belt conveyor or cross-belt sorter, tipping bowl sorter or sorter. The cross-belt conveyor is a conveying system which is typically conceived primarily to move objects along the conveying direction as a main transport direction and transversely with respect to the conveying direction during unloading. The system makes it possible in particular to displace and/or distribute objects laterally relative to the conveying direction, be it to bring the objects to a standstill, to distribute them to a further handling station and/or to bring them to another conveyor device. The cross-belt conveyor typically has a multiplicity of transversely arranged conveyor belts or tippable carriages, which are moved along the conveying direction. The conveyor belts or carriages can be moved independently of one another to unload the objects, in order to unload or to distribute objects at specific locations and/or stations.

The conveyor device can be designed as a tray sorter. This has a multiplicity of conveyor apparatuses with a mechanism which conveys and ejects the objects using carriers in the form of trays or chambers. The tray sorter can be designed as a tilting bowl sorter, as a split tray sorter or as a push tray sorter.

The conveyor device, in particular the cross-belt conveyor, can comprise integrated scanners or other detection systems as detection apparatus(es), which participate in the conveyance of the objects, in particular the sorting and distribution of the objects. The detection apparatus refers in particular to a fixedly installed monitoring and/or detection system which, for example, is designed to detect various portions and/or parts of the conveyor line and/or objects located thereon. The detection apparatus can have one or more components such as light barriers, cameras, sensors, scanners or other measuring devices which are able in particular to continuously collect data about the state of the conveyor apparatuses and the properties of the transported objects. The detection apparatus is typically permanently integrated and/or connected directly to the conveyor line, which means that permanent or any-time detection, monitoring and/or data capture is made possible. The detection apparatus can, for example, detect dimensions, weight, type, attitude and/or state of an object. The detection apparatus and/or the maintenance apparatus can identify or locate technical states or malfunctions of the conveyor line. Typically, the information obtained by the detection apparatus is used in the distribution of objects. If a detection apparatus does not function or is incorrectly aligned, this can lead to disruptions during operation and/or can lead to the stoppage of the conveyor device.

The sensor system for detecting the conveyor line relates in particular to sensors, sensor arrangements and/or apparatuses having sensors, which are designed to collect information about the upper side and/or underside of the conveyor line. The sensor system is in particular designed or specifically configured to detect the conveyor line. The sensor system can be used to detect features such as three-dimensional stretching, a state of wear, damage/defects or other structural properties of the conveyor line. The sensor system can comprise at least one camera, an optical sensor, ultrasonic sensor, radar sensor, laser sensor, lidar sensor, infrared sensor, sound sensor, vibration sensor, acoustic sensor, vibration sensor and/or a sensor acting tactilely in order to be able to obtain the information. Depending on the application, different sensors may be expedient. The sensor system can be configured in such a way that it measures static and/or dynamic properties, such as vibration patterns of the conveyor line, which can provide information about the running operating state.

The actuator apparatus comprises in particular a movable system or aid which can carry out maintenance and repair work on the conveyor line. The actuator apparatus can comprise various types of actuators, in particular robot arms, tool carriers and/or specific modules or tools which can be used for maintenance work such as lubrication, cleaning, repair, replacement of worn parts or adjustments. The actuator apparatus is, for example, equipped with a control system which in particular is configured for control on the basis of the information obtained and/or on the basis of user commands. The actuator apparatus or the control system can be programmed to carry out maintenance work, for example in order not to disrupt the operation of the conveyor device, or to disrupt it as little as possible. The maintenance apparatus, in particular with the actuator apparatus, can contribute to increasing the availability of the conveyor device, in that it reduces the necessity for manual interventions and basically carries them out itself. At the same time, the maintenance apparatus, in particular with the actuator apparatus, can improve operational safety in that it keeps human beings away from potentially dangerous maintenance tasks.

The comparison of the information obtained with previously known information about the conveyor line is in particular a computer-implemented method step. The comparison relates in particular to a target-current comparison. Firstly, the current environment can be detected; secondly, the current environment can be compared with an original or desired target environment. In the event of sufficient deviations between the items of information, for example, a geometric deviation can be inferred. It is possible to detect not only the presence of the geometric deviation but also its location, using the information obtained. The localization means in particular the recognition and the location of the deviation. The comparison is advantageously used to check the function and/or alignment of the detection apparatus. Here, deviations between current and target also show appropriate evidence that the detection apparatus is not properly aligned or not functioning.

Further possible configurations of the invention, which can advantageously be used in the conveyor device and the method, are indicated below.

The maintenance apparatus is, for example, an apparatus carried along on the conveyor line. The maintenance apparatus can be designed to be able to be placed on or able to be attached to a conveyor apparatus. The maintenance apparatus can in particular be fastened to a support of a conveyor apparatus. The maintenance apparatus can also be guided movably along the conveyor line on one or a plurality of conveyor apparatuses in a row, in particular wherein the maintenance apparatus in this case can form an integral constituent part of the conveyor line. To this extent, a conveyor apparatus can be exchanged with the maintenance apparatus.

The conveyor device can have a detection apparatus permanently installed on the conveyor line. The detection apparatus can be fixed in location, i.e. not moved along during the movement of the conveyor apparatus(es). The detection apparatus can have a sensor and/or a light barrier, for example with which objects can be detected and/or measured. Typically, the detection apparatus is arranged and aligned at a specific height and/or at a specific angle with respect to the conveyor apparatus(es). The detection apparatus can be adjusted. During proper function of the detection apparatus, this can detect objects at a specific height for example and/or detect whether the respective conveyor apparatus is conveying an object.

The sensor system can have a camera on the upper side and/or a camera on the underside. For example, the sensor system or the camera can be aligned in the conveying direction and/or counter to the conveying direction, and/or pointing upward or downward. The sensor system can be directed toward the nearest conveyor apparatus(es). The sensor system can in particular detect an enclosure of the conveyor line. The sensor system can provide an image or video signal as information. The signal from the camera makes it possible to be able to detect locations to be maintained, objects that have been left behind, geometric deviations in the conveyor line or the like.

Advantageously, the sensor system can have a lighting apparatus for illuminating the conveyor line. The lighting apparatus is in particular designed or specifically configured to illuminate the conveyor line. The lighting apparatus has, for example, an LED light source in particular in conjunction with a reflector for the light emerging from the LED light source. A camera can be combined with the lighting apparatus in order to obtain a particularly bright and contrast-rich image or video signal from the often poorly illuminated inner parts of the conveyor device.

In particular, the sensor system can be directionally adjustable by motor. For example, camera and lighting apparatus can be jointly directionally adjustable. An adjusting motor can be provided. For example, provision can be made to be able to directionally adjust the sensor system in an active range of at least 45°, preferably at least 90°, preferably at least 180°, in particular 360°. For example, the active range can extend in a horizontal plane of the conveyor line and around a vertical axis or height axis. To this extent, up to a complete revolution of the sensor system about the vertical axis can be carried out. The sensor system can optionally also be directionally adjusted around one or two further axes in space. Thus, an inspection can be carried out purposefully along the conveyor line, starting from the maintenance apparatus, in particular during the operation of the conveyor device.

A remote control for remotely controlling or remotely operating the conveyor line and/or the maintenance apparatus can be provided. The remote control is in particular designed or specifically configured for the remote control or remote operation. The remote control is in particular designed for the display or for the indication of the information, for example by means of a display. The remote control can be designed as a mobile and/or battery-operated device. The remote control can be provided by a computer device, for example laptop, smartphone and/or tablet computer. The remote control typically has an input device, for example a keyboard and/or a touchscreen, and/or an output device, for example display and/or loudspeaker. The remote control can, for example, be configured to directionally adjust the sensor system and/or specify a conveying speed and/or conveying direction of the conveyor line. The remote control is in particular designed for communication with the maintenance apparatus, for example in order to transmit the information and/or to send control commands. The communication is preferably cable-free and/or cabled and/or bidirectional communication, for example using a cable-free communication method such as 4G, 5G, WLAN and/or Bluetooth. The remote control makes the maintenance or repair of the conveyor device easier.

Preferably, a visualization apparatus is provided. The visualization apparatus can have a display and/or a projection device, for example in order to display or to visualize the information. The visualization apparatus is in particular designed to display the information by means of augmented reality and/or virtual reality. The visualization apparatus can comprise 3D glasses, VR glasses or the like. The visualization apparatus can, for example, communicate with the remote control and/or the maintenance apparatus, in particular in a cable-free and/or cabled and/or bidirectional manner, for example by using a/the cable-free communication method such as 4G, 5G, WLAN and/or Bluetooth.

For example, by means of the visualization apparatus, the information, in particular an image or video signal, can be displayed, in particular in real time. It is possible that the information is displayed with image stabilization. For example, vibrations of the maintenance apparatus and/or the conveyor apparatus(es) can be compensated.

In particular, the maintenance apparatus is configured to be able to be operated independently of the remainder of the conveyor device. In particular, the maintenance apparatus is operable independently of a plant control system of the conveyor device that controls the conveyor apparatus or conveying line.

Preferably, a location apparatus for determining a position of the maintenance apparatus along the conveyor line is provided. In particular, the maintenance apparatus has a marking in order to mark a position of the maintenance apparatus optically. The marking can be a conspicuous element, for example a flag. Alternatively or additionally, a lamp can be provided as a marking. The location apparatus can also have a loudspeaker in order to output sounds. Alternatively or additionally, the location apparatus can determine a position of the maintenance apparatus along the conveyor line and provide the position as part of the information. By means of the location apparatus, a user can more easily detect the place at which the maintenance apparatus is located.

The conveyor line can comprise an enclosure, in particular to cover the conveyor apparatus at the side and/or on the underside. The enclosure can be provided at least in some sections along the conveyor line. The enclosure can have openings or flaps in order in particular to obtain access to the conveyor line from a lateral direction in some sections. The enclosure preferably has at least one side wall or two opposite side walls. A gap, for example with a width of at least 0.5 cm and, for example, at most 10 cm, can be provided between the conveyor apparatus and the enclosure or side wall. The enclosure can be designed to laterally delimit, or as a boundary limit of, the conveyor line. The enclosure can serve as a boundary limit on the sides of the conveyor apparatus(es). The enclosure ensures in particular that there is lateral protection and possibly protection from above or below. The enclosure in particular protects the moved conveyor apparatus against unintended personal interventions. The enclosure can be provided as a guide aid for objects and/or conveyor apparatuses.

Advantageously, the maintenance apparatus has an in particular remotely operable actuator apparatus. The actuator apparatus is in particular designed or specifically configured to carry out maintenance work on the conveyor line. The actuator apparatus is in particular designed to carry out movements in space and relative to the conveyor line. For example, the maintenance apparatus can be remotely operated by means of a/the remote control, wherein the actuator apparatus is able to carry out a controlled movement and/or maintenance work in the process. For example, the actuator apparatus can be designed or specifically configured to exchange, move and/or deform parts or sections of the conveyor apparatus and/or objects. The actuator apparatus is typically distinguished by the fact that it is able to carry out an actuated relative movement in relation to the conveying line or to a conveyor apparatus, in particular relative to the maintenance apparatus itself apart from the actuator apparatus. The actuator apparatus can be designed to be electrically, hydraulically and/or pneumatically controllable. It is also possible for a plurality of actuator apparatuses to be provided, for example one or more on the upper side and/or one or more on the underside. Typically, the actuator apparatus has one or more drives.

Advantageously, the actuator apparatus can have a robot arm or be formed by a robot arm, in particular wherein the robot arm is provided with the sensor system and/or a tool preferably for moving an object, or has the latter. The tool is in particular designed or specifically configured to move an object. The tool can, for example, have a gripper. It is possible for a plurality of tools to be provided, in particular on a robot arm. The robot arm typically has a plurality of pivot axes spaced apart from one another and at least one robot arm element with at least two of the pivot axes. According to experience, a robot arm is very flexible in relation to incidental repairs and maintenance work.

In the method proposed here, a geometric deviation can be located by comparing the information obtained with the previously known information. The geometric deviation can comprise an object that has been left behind and/or is firmly jammed. Alternatively or additionally, the geometric deviation can be or comprise an enclosure of the conveyor line which is open at least in some sections and/or defective. Alternatively or additionally, the geometric deviation can be or comprise damage to the conveyor line, a crack or a fissure and/or traces of wear or abrasions. Alternatively or additionally, the geometric deviation can be or comprise an in particular coarse contamination. It has transpired that these geometric deviations are a frequent source of faults during the operation of the conveyor device. In addition, it has transpired that these geometric deviations can be detected easily with the method proposed. For example, the conveyor line can be monitored and/or inspected during operation by means of the comparison, in order to detect problems quickly and to stop their cause.

In the method proposed here, the function and/or alignment of the detection apparatus can be checked by comparing the information obtained with the previously known information. For example, it is possible to establish the height at which the detection apparatus or the light barrier has been set, how it is aligned and/or whether it is functioning properly. Signal monitoring of the detection apparatus can be carried out. Overall, in this way the functionality of the conveyor device can be checked, for instance in order to be able to intervene in the event of irregularities. For example, the conveyor line can be detected in one section using the detection apparatus. The previously known information can in particular relate to the detection apparatus or the section having the detection apparatus. To this extent, the comparison can relate to the detection apparatus in a focused manner, in order to ensure its function.

The conveyor line can be detected all round. For example, the conveyor line can be detected continuously, during each pass and/or substantially permanently, in order to be able to react to problems as far as possible in real time. Thus, the conveyor line can be detected alternatively or additionally at regular time intervals, for example hourly or daily, in order to save resources.

The operation and the detection and optionally the comparison can be carried out simultaneously. The steps of the method can overlap in time or else be carried out one after another. In principle, the detection can be carried out during the movement and likewise independently of the movement. The comparison can also be carried out subsequently, for example by the information first being collected and evaluated later by the comparison.

Operation, detection and comparison are preferably carried out simultaneously, in order to be able to detect problems on the conveyor line as quickly as possible.

The maintenance apparatus can be fastened on and/or under the conveyor apparatus, in particular thereto. For example, the maintenance apparatus can be fastened and/or fixed to the respective conveyor apparatus. This ensures that the information obtained at different times is as uniform as possible. The uniformity of the information obtained can also be improved in conjunction with the enclosure.

Provision can be made for the previously known information to be generated by means of an initial detection of the conveyor line by means of the maintenance apparatus. The initial detection is preferably carried out when the conveyor line is operationally ready to convey objects and is in an initial state. In other words, the conveyor line should be fault-free and in the ideal state when the previously known information is detected. It is also conceivable that information obtained is made previously known information, in order to be able to detect spontaneously occurred and/or minimal geometric deviations.

In the method, the maintenance apparatus can be remotely operated, in particular wherein the information is displayed and/or stored by means of a/the remote control and/or a/the visualization apparatus which is designed for the display of the information by means of augmented reality and/or virtual reality. For example, a user can remotely control the conveyor line in order to move the maintenance apparatus to the geometric deviation and/or to the detection apparatus, in particular while the user obtains a visual insight into the interior of the conveyor device.

In the method, the maintenance apparatus can carry out maintenance work. The maintenance work can be carried out as a result of a user command and/or under user control. The maintenance work can comprise a repair of the conveyor line and/or a movement of an object that has been left behind and/or an alignment and/or testing of the function of the detection apparatus. For example, parts of the conveyor device can be inspected, repaired and/or exchanged. The detection apparatus can be height-adjusted and/or signal monitoring of the detection apparatus can be carried out. In the method, provision can finally be made for maintenance or a repair to be carried out on the conveyor line. In particular, a local defect, for example an object that has been left behind, a geometric deformation and/or an adjusted detection apparatus, can be eliminated by user operation, with the aid of the actuator apparatus and in particular under control by means of remote control and/or visualization apparatus. For example, the maintenance apparatus can set or adjust the detection apparatus, in particular automatically.

Information obtained and/or data relating to the maintenance work carried out can be stored in a database. Repeated maintenance work can be carried out in an automated manner while taking the stored data into account. The database can be provided by the maintenance apparatus, the remote control, a central computer device or a, preferably fixed-location, data preservation system and/or a cloud. A buffer can be provided. It is possible that the conveyor device is constructed in such a way that a temporary interruption of a, preferably cable-free, communication link between the maintenance apparatus and the database does not lead to the data loss. The information or data not transmitted as a result of a temporary interruption can be buffered in the buffer and transmitted to the database when the data link is restored.

In particular, a learning system can be provided, in which maintenance work or repairs already carried out are stored and can automatically be executed later upon reoccurrence in accordance with an already known pattern. The repeated maintenance work can relate not only to repairs but also objects that have been left behind or jammed, or alignment and checking of the detection apparatus. For example, it is possible that maintenance and/or repair of a specific point of the conveyor line is carried out automatically when the maintenance apparatus has been trained appropriately. For example, lubrication of specific mechanical parts can be automated. In addition, points of the conveyor device that are susceptible to the jamming of objects can be processed automatically by moving the object by means of the maintenance apparatus.

The geometric deviation can comprise a particularly coarse contamination and/or a point of the conveyor line that is to be cleaned or is contaminated. The maintenance apparatus can be designed to clean the conveyor line and/or the detection apparatus. For example, the maintenance apparatus can have a cleaning agent or a cleaning tool, for example a brush or a compressed air nozzle for the directed discharge of compressed air. The robot arm can be designed for the cleaning. For example, the cleaning agent or cleaning tool can be used on the conveyor line by means of the robot arm. In the method, cleaning by the maintenance apparatus can be provided, for example cleaning of the conveyor line and/or of the detection apparatus, in particular with mechanical contact (e.g. brush) and/or without contact (e.g. compressed air).

The conveyor device and the method can be advantageously developed in each case with the following features.

The maintenance apparatus can have a cleaning system. The cleaning system can be understood as a cleaning agent or cleaning tool or comprise one such. The cleaning system can at least partly or wholly be a constituent part of the tool.

The cleaning system can be configured to loosen contaminants on the conveyor line. The cleaning system can be configured to pick up contaminants. For example, the cleaning system can have a collecting system for contaminants. The cleaning system can be configured to suck off or suck up contaminants or have a suction system and/or a vacuum cleaner. The cleaning system can provide a/the vacuum unit. At least in some sections, the cleaning system can be fastened to the actuator apparatus. The cleaning system can have an, in particular rotating, brush system and/or scraper system which can loosen, in particular firmly stuck, contaminants and/or can supply suction. The brush system and/or scraper system can draw its energy required for operation from the movement of the maintenance apparatus along the conveyor line.

The cleaning system is in particular designed in such a way that self-ignition, explosion and/or burning of contaminants that are picked up is prevented. For example, contaminants can be collected in such a way that the lowest possible production of dust originates from the collected contaminants in the maintenance apparatus. For example, the collection system has a filter in order to avoid or to reduce dust in waste air. For example, the cleaning system is designed to expel in particular filtered waste air substantially counter to a direction of movement of the maintenance apparatus. For example, a moistening system for moistening the contaminants can be provided. For example, an extinguishing system for extinguishing a fire can be provided. For example, a system for dissipating static charges of the maintenance apparatus can be provided in order to avoid spark discharges.

The maintenance apparatus can have a pick-up system in order to pick foreign bodies up from the conveyor line and/or to deposit them in a receiving container of the pick-up system. The pick-up system and/or the cleaning system can have a/the filter in order to retain dust. The pick-up system can be a constituent part of the cleaning system or of the collecting system.

The conveyor line can have a rail and, in particular, a sheet metal construction and/or a carrier construction for fastening the rail. The maintenance apparatus and the conveyor apparatus(es) can be moved along the rail and in contact with the rail. The drive of the conveyor line can be configured to drive the maintenance apparatus(es) and conveyor apparatus(es) arranged at/on the rail.

The maintenance apparatus can be configured to detect or for detecting cracks on the conveyor line or in parts thereof. Cracks can be located or localized. The detection can be implemented within the context of the comparison. Cracks can be understood as a geometric deviation. For example, cracks in the rail, the sheet metal construction and/or the carrier construction of the conveyor line can be detected. To detect cracks, a marker substance can be used and/or applied to the conveyor line by the maintenance apparatus, for example a fluorescent and/or UV-sensitive marker substance. The marker substance can collect in gaps or cracks as a result of capillary forces when surfaces are wetted with said substance, so that the gaps or cracks become visually easily detectable.

The maintenance apparatus can illuminate the marker substance and information with respect to the cracks can be obtained via the sensor system. For example, photographs that can be evaluated can be taken. For example, cracks can be recognized and located by a computer-implemented analysis of the information. For example, the lighting apparatus can carry out UV-light irradiation in order to be able to detect cracks by means of the UV-sensitive marker substance. It is also possible to use a camera or an optical monitoring system with a polarizing filter. For example, cracks can be detected by means of ultrasonic testing.

The sensor system, in particular the camera, can have a/the polarizing filter, for example in order to reduce disruptive reflections and/or for detecting cracks.

The maintenance apparatus can have a collision protection system in order to avoid collisions with foreign bodies and/or objects or to reduce their effects. The collision protection system is, for example, designed to detect contaminants or foreign bodies. The collision protection system can stop the conveyor device, in particular the maintenance apparatus(es) and/or the conveyor apparatus(es), in order to avoid collisions. For example, the collision protection system can generate an emergency stop signal and send it at least indirectly to the drive in order to stop the latter.

The maintenance apparatus can be battery-operated and in particular supplied with electricity along the conveyor line or by the conveyor line. The maintenance apparatus can have a power supply, for example a power store, which travels along with the maintenance apparatus. The power store can comprise a battery or an accumulator. Independent operation of the maintenance apparatus may be made possible with the power supply.

The maintenance apparatus can have at least one mounting bracket, for example in order to arrange the sensor system and/or further sensor system for detecting the conveyor line or for obtaining information, respectively, thereon. For example, the (further) sensor system can be configured for vibration measurement and/or load measurement. The at least one mounting bracket can be arranged at a point of the maintenance apparatus that is relevant to the respective measurement, for example in the area of a roller, in particular carrier roller and/or guide roller, of the maintenance apparatus.

The maintenance apparatus or the sensor system can be designed to monitor noise and/or to monitor vibration, in particular for monitoring on the maintenance apparatus itself. For example, during movement of the maintenance apparatus, the acoustics can be monitored on the maintenance apparatus in order to draw conclusions about the need for maintenance on the conveyor line. It is also possible to draw conclusions about the need for maintenance on the maintenance apparatus itself. For example, the acoustics change when rollers on the conveyor device or maintenance apparatus wear. Via the acoustics, irregularities and/or faults in the course of the conveyor line, which can also be referred to as geometric deviations, can be detected.

The maintenance apparatus or the sensor system can be designed as an acoustic and/or vibration diagnosis system and/or have this system, for example in order to detect irregularities in the rolling behavior of rollers, in particular carrier rollers and/or guide rollers, of the maintenance apparatus and/or the conveyor apparatus and to locate them along the conveyor line. The diagnosis system can detect and locate irregularities in track conditions or geometric deviations in the conveyor line.

The maintenance apparatus can be configured for online diagnostics or live diagnostics and/or to record diagnostics. To this extent, the information obtained by means of the sensor system can be evaluated or displayed directly and/or recorded or stored. Storage is carried out in particular in a/the database.

The maintenance apparatus can have a communication system or a communication interface, which can be designed for in particular cable-free and/or cabled communication, preferably with a/the remote control. The communication is preferably cable-free and/or cabled and/or bidirectional communication, for example using a cable-free communication method such as 4G, 5G, WLAN and/or Bluetooth.

The maintenance apparatus or the sensor system can be configured for, preferably vertical, distance monitoring, in particular to detect a clearance dimension or a clearance between the conveyor apparatuses and drives of the conveyor line and/or between the conveyor apparatuses and rails of the conveyor line. The clearance dimension is preferably also present between the maintenance apparatus and drive or rails. The clearance dimension can be one of the items of information obtained. Preferably, the conveyor apparatuses are each arranged at least substantially parallel to a drive or a rail, i.e. arranged parallel to a drive or a rail along the conveyor line and/or transversely with respect to the conveyor line. Deviations relating to the parallelism can be detected by means of clearance measurement.

The maintenance apparatus can be designed to measure a/the clearance or clearance dimension of the conveyor line. The maintenance apparatus or the sensor system can comprise a measuring system for clearance measurement between the drive or linear drive of the conveyor line and a floor and/or the underside of the maintenance apparatus and/or between the drive or linear drive of the conveyor line and a floor and/or the underside of a conveyor apparatus. Each drive of the conveyor line can be assigned at least one, preferably more, clearance or clearance dimension to this extent. The measuring system can assess the clearance dimensions, for example with regard to the decision as to whether there is a need for maintenance on one or more drives or not. The measuring system can measure the clearance, for example in a camera-based or optical manner. The measuring system can measure the clearance, for example, by means of a lidar or radar sensor and/or with laser support.

Clearances or clearance dimensions can be measured, in particular during a movement of the conveyor apparatus(es) and the maintenance apparatus(es), along the conveyor line and/or transversely with respect to the conveyor line. Clearances along the conveyor line can indicate misalignments or longitudinal distortions of conveyor apparatuses. Clearances transversely with respect to the conveyor line can indicate transverse distortions of conveyor apparatuses. In the event of an incorrectly adjusted, for example excessively low, clearance dimension, it is possible for rubbing or jamming or malfunctions to occur during operation.

In order to set a clearance, for example, a position of a drive on the conveyor line can be adjusted. This can be done automatically or manually.

It is possible that information obtained is stored reproducibly, in particular in a/the database.

The information obtained comprises in particular a location or locating information. The geometric deviations, in particular the clearance dimensions, can be determined on the basis of location. The clearance dimensions can be located along the conveyor line and/or assigned to an individual drive of the conveyor line. The localization can be implemented to this extent.

The maintenance apparatus can be designed to measure forces along the conveyor line, in particular a tensile force and/or a compressive force between the maintenance apparatus and the nearest conveyor apparatus, for example in order to detect binding along the conveyor line. For example, impermissible load-change cycles between conveyor apparatuses can be detected and localized.

Within the context of the disclosure, the German abbreviation “bzw.” represents a short form of “beziehungsweise (respectively; or)” and is intended in principle to indicate alternative, basically equivalent and/or synonymous features or terms in order to introduce the idea or the sense of a use of feature or term. “Beziehungsweise” can always be replaced by “und/oder (and/or)”.

The invention is explained further in detail below using a preferred exemplary embodiment with reference to the drawings.

In the drawings:

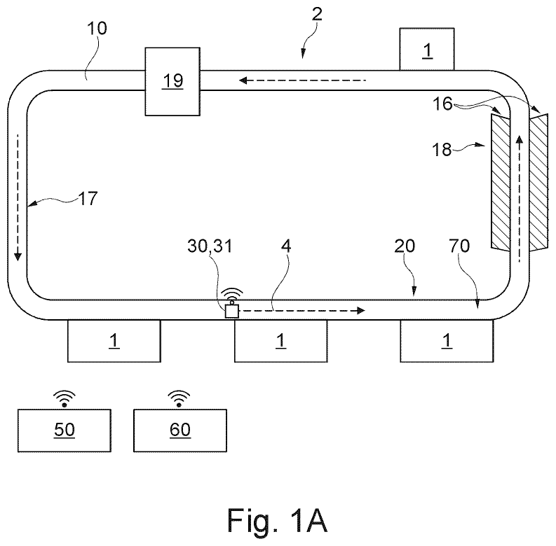

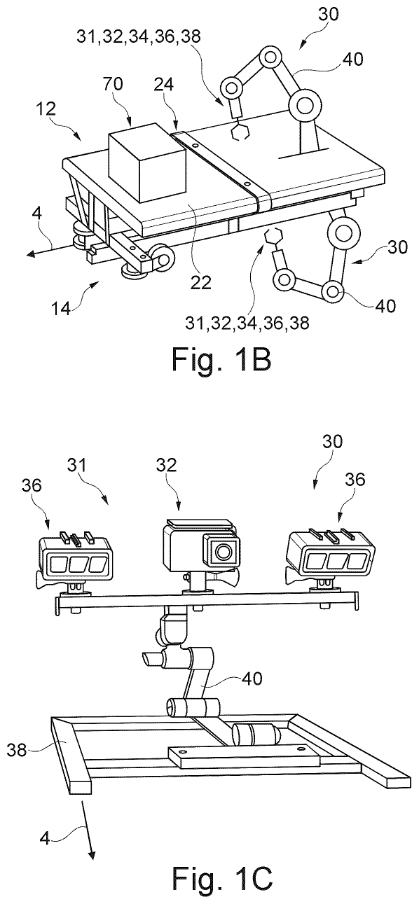

FIG. 1A shows a conveyor device for conveying objects and having maintenance apparatuses in a schematic view,

FIG. 1B shows a maintenance apparatus and a conveyor apparatus of the conveyor device, coupled thereto in a line, in a perspective view, and

FIG. 1C shows a maintenance apparatus of the conveyor device in a perspective view.

If the same reference signs are used in the figures, the following description applies correspondingly among the figures. Examples which can be modified and/or supplemented in various ways within the context of the claims are described. Each feature which is described for a specific example can be used independently or in combination with other features in any other example. Each feature which is described for an example of a specific category of claim can also be used in a corresponding way in an exemplary embodiment, for example of another category of claim or another aspect of the invention.

FIG. 1A shows a conveyor device 2 which is designed to convey objects 70, having a conveyor line 10 circulating endlessly or annularly or circularly along a conveying direction 4. A multiplicity of conveyor apparatuses 20, not illustrated in detail, and a maintenance apparatus 30 lined up in a row or coupled to one another are movably guided along the conveyor line 10. Drives 17 along the conveyor line can move this chain of the conveyor apparatuses 20 and the maintenance apparatus 30 onward in circulation.

A further maintenance apparatus 30 is placed on one of the conveyor apparatuses 20 or fastened thereto. The conveyor apparatuses 20 are each designed to unload an object 70 resting or conveyed thereon transversely with respect to the conveyor line 10. Connected to the outside of the conveyor line 10 are a plurality of sorting or processing stations 1, from which objects 70 can be loaded onto the conveyor apparatuses 20 or unloaded from the conveyor apparatuses 20 to the stations 1. In particular, the conveyor device 2 is designed as a cross-belt sorter or cross-belt conveyor. Alternatively or additionally, the conveyor device 2 is designed as a tray sorter.

In the present case, these are remotely controllable or remotely operable maintenance apparatuses 30, i.e. the maintenance apparatuses 30 can transmit information and optionally receive and carry out commands.

Not illustrated is a conveyor device having a conveyor line, wherein exactly one conveyor apparatus is movably guided along the conveyor line. For example, this could be a belt conveyor, wherein a maintenance apparatus is placed on the belt conveyor or is fastened thereto and is carried along with it. The belt conveyor can be designed to be endless or else to circulate as a line section having at least two ends.

Not illustrated is a conveyor device having a conveyor line, wherein a plurality or a multiplicity of conveyor apparatuses for conveying objects are movably arranged along the conveyor line. For example, this could be a roller conveyor, wherein a maintenance apparatus is placed on the roller conveyor and is carried along with it. The roller conveyor can be designed to be endless or else to circulate as a line section having at least two ends.

Furthermore, in FIG. 1A a detection apparatus 19 permanently installed on the conveyor line 10 is provided, which has a light barrier on the upper side, for example with the function of detecting objects 70 at a specific height or not detecting them depending on the height. The detection apparatus 19 is adjustable and can be aligned.

The conveyor line 10 has an enclosure 16, in order to cover the conveyor apparatuses 20 and the maintenance apparatuses 30 at the side and optionally on the underside. The enclosure 16 can be opened in some sections, for example by means of covers 18 or flaps, in order to obtain access to the conveyor line 10. The covers 18 or flaps can be understood as fences.

It is possible that objects 70 jam between conveyor apparatuses 20 and the enclosure 16 or get into a gap. Reference is then made to an object 70 that has been left behind or an item of mail that has been left behind. If objects 70 are comparatively flat, they can also get into the area underneath the conveyor line 10, i.e. toward the underside.

FIG. 1B shows, in a detail of the conveyor device 2 from FIG. 1A, an individual conveyor apparatus 20, which is coupled to the maintenance apparatus 30 in a line for common movement. The conveyor apparatuses 20 each have a support 22 for supporting the objects 70, which can be tilted transversely with respect to the conveying direction 4 to unload the objects 70 respectively lying thereon and/or which is a conveyor belt that is oriented transversely with respect to the conveying direction 4 and can convey away and unload the objects 70 respectively lying thereon transversely with respect to the conveying direction 4. The conveyor apparatuses 20 are coupled to one another and, likewise, the conveyor apparatus 20 shown is coupled to the maintenance apparatus 30 in a coupling area 24. The coupling area 24 creates range of movement, for example in curves of the conveyor line 10.

The conveyor apparatuses 20 and the maintenance apparatus 10 are provided with rollers, which are guided on guides or rails of the conveyor line 10. The rollers are designed, for example, as carrier rollers or supporting rollers and/or guide rollers. Carrier rollers are provided substantially to carry load. Guide rollers are provided substantially for guiding and steering.

The maintenance apparatus 30 in FIG. 1B in the present case, and also the conveyor apparatuses 20, is rail-guided and can be moved at the same speed with the conveyor apparatuses 20. The maintenance apparatus 30 can be viewed as a maintenance cell. The maintenance apparatus 30 in the present case has two remotely operable actuator apparatuses 40, which are designed to carry out maintenance work on the conveyor line 10, wherein the actuator apparatuses 40 each have a robot arm, and wherein the respective robot arm is provided with a sensor system 31 and a tool for gripping and moving an object 70.

The tool can have a sucker and/or a device for gripping objects 70 by means of vacuum. Objects 70 can therefore be attracted by suction as desired, in order to be fastened temporarily to the tool and to be able to be moved.

The sensor system 31 is in each case designed to detect the conveyor line 10 in order to obtain information relating to an upper side 12 and an underside 14 of the conveyor line 14. The sensor system 31 has a camera 32 on the upper side 12 and a camera 34 on the underside 14. In addition, the sensor system 31 has a lighting apparatus 36 for illuminating the conveyor line 10, preferably from the inside and/or in the field of view of the camera 32, 34. The sensor system 31 is directionally adjustable by motor. In particular, the camera 32, 34 and/or the respective robot arm can be directionally adjusted.

The maintenance apparatus 30 optionally has a location apparatus 38 for determining a position of the maintenance apparatus 30 along the conveyor line 10. The maintenance apparatus 30 has a marking, for example a flag, in order to optically mark a position of the maintenance apparatus 30, in particular easily detectably from outside.

FIG. 1C shows the further maintenance apparatus 30 of the conveyor device 2, which can be fastened to a conveyor apparatus 20, for example placed thereon and/or fastened thereto, in order to be moved along the conveying direction 4. The maintenance apparatus 30 has a camera 32 on the upper side 12 and at least one lighting apparatus 36. The camera 32 and the lighting apparatus 36 are optionally directionally adjustable via an actuator apparatus 40. Instead of or in addition to the actuator apparatus 40, a manually adjustable arm can also be provided.

The sensor system 31, in particular a camera 32 or 34 or both cameras 32, 34, is provided with a polarizing filter.

With a view of FIG. 1A, a remote control 50, which is designed for the remote operation of the conveyor line 10 and the maintenance apparatuses 30, in particular the actuator apparatuses 40, is provided, wherein the remote control 50 is designed to display the information. The maintenance apparatuses 30 can transmit the information. The remote control 50 can store the information, for example in a database. The remote control 50 is designed for cable-free communication with the maintenance apparatuses 30 and optionally with the conveyor line 10. Via the remote control 50, the conveyor device 2 can be moved in particular by a user input, and/or a camera 32, 34 or one of the robot arms can be directionally adjusted. The information obtained by the sensor system 31 can at least partly be seen on the remote control 50. For example, a user can see whether and where an object 70 has jammed. A smartphone, a tablet and/or a computer with monitor can be used as the remote control 50, which is able to communicate with the maintenance apparatus or apparatuses 30 via a cable-free communication method, for example 4G, 5G, WLAN and/or Bluetooth.

The maintenance apparatus 30 is configured to detect cracks on the conveyor line 10. For example, information that makes it possible to detect the cracks can be obtained by means of the sensor system 31, in particular one or both cameras 32, 34. The maintenance apparatus 30 can carry out a comparison of the information obtained with previously known information in particular within the context of an operating method, in order to detect cracks. A marker substance can be used and/or cracks can be detected photo-optically.

Optionally provided is a collision protection system of the maintenance apparatus 30, in order to detect a collision of the maintenance apparatus 30 with objects 70 and/or foreign bodies. The collision protection system can stop the conveyor device 2, for example when a collision is threatened.

In the present case, the maintenance apparatus 30 is provided with a power store or is battery-operated, e.g. in order to operate the cleaning system and/or the sensor system 31.

The maintenance apparatus 30 is configured for online diagnostics. This means that it can be maintained in real time and/or diagnoses can be carried out in real time.

The maintenance apparatus 30 is designed to monitor noise or to monitor vibration. For example, a diagnostic system is provided in order to detect and locate irregularities in the rolling behavior of guide rollers. Furthermore, the maintenance apparatus can measure a clearance of the conveyor line 10. By means of this combination, a need for maintenance can advantageously be identified in a simplified manner.

The maintenance apparatus 30 is configured for distance monitoring and, within the context of the information obtained or within the context of the comparison, can detect or measure the clearance or a clearance dimension between conveyor apparatuses 20 and drives 17 of the conveyor line 10. For example, the clearance dimension on the underside 14 can be detected by means of the sensor system 31, in particular the camera 34. A multiplicity of clearance dimensions can be determined, in particular based on the location along the conveyor line 10, and assigned to individual drives 17.

The maintenance apparatus 30 can further determine a tensile force or a compressive force, for example in the coupling area to the nearest conveyor apparatus 20, in order to be able to detect load-change cycles along the conveyor line 10. The sensor system 31 can determine the tensile force or compressive force. The tensile force or compressive force can be taken into account within the context of the information obtained or within the context of the comparison, in order to detect binding and to possibly identify a need for maintenance and optionally to locate it along the conveyor line 10.

The maintenance apparatus 30 can have one or more mounting brackets, for example on the upper side 12 and/or the underside 14. Systems and/or the sensor system 31 can be fastened, in particular releasably, to a mounting bracket. For example, one mounting bracket is in the area of a guide roller of the maintenance apparatus, in order to provide the sensor system 31 there.

Optionally provided is a visualization apparatus 60, which is designed for the display of the information by means of augmented reality and/or virtual reality. This can be VR glasses, which are worn by a user concerned with maintaining the conveyor device 2. The visualization apparatus 60 can communicate in interaction with the remote control 50 or on its own with the maintenance apparatus or apparatuses 30, in order to display the contents and/or to control the conveyor line 10 and/or the maintenance apparatus 30. The visualization apparatus 60 can communicate with the maintenance apparatus or apparatuses 30 and/or the remote control 50 via a cable-free communication method, for example 4G, 5G, WLAN and/or Bluetooth.

Alternatively or additionally, the visualization apparatus 60 is a display or an indicator, for example on the remote control 50.

The visualization apparatus 60 can display the information or at least some of the information. For example, an image or video signal can be provided as a live transmission from the conveyor line 10 to the maintenance apparatus 30 as part of the information, which is displayed by the visualization apparatus 60. The information can be displayed with image stabilization, for example when the maintenance apparatus 30 is in motion. The information, including location information along the conveyor line 10, can be displayed and/or recorded in order to be able to localize the information immediately or else subsequently.

An operating method of the conveyor device 2 comprises moving the maintenance apparatus 30 or maintenance apparatuses 30 along the conveyor line 10, in particular by the conveyor apparatuses 20 being moved. The maintenance apparatus 30 is in particular moved by exerting a force from the drive 17 and in particular via the conveyor apparatuses 20. The operating method is in particular at least partly computer-implemented.

The operating method further comprises detecting the conveyor line 10 by means of the maintenance apparatus(es) 30 in order to obtain the information. The sensor system 31 detects the upper side 12 and the underside 14, so that a user can optically inspect hard-to-reach and/or enclosed points of the conveyor line 10.

The operating method further comprises comparing the information obtained with previously known information about the conveyor line 10. The comparison is provided, for example, for checking the function and alignment of the detection apparatus 19 and for localizing a geometric deviation in the conveyor line 10. The geometric deviation can be an object 70 that has been left behind or is jammed or else contaminants and an enclosure 16 which is open in some sections or defective.

In the operating method, the conveyor line 10 is detected all round by means of the maintenance apparatus 30. Thus, it is quickly detected whether and where a geometric deviation is present. The operation, the detection and the comparison are carried out simultaneously, wherein in particular the detection and the comparison predominantly or substantially are computer-implemented steps.

Alternatively or additionally, the conveyor line 10 in the section with the detection apparatus 19 is detected, wherein the previously known information relates to the detection apparatus 19. In principle, here the operating method can be focused on the inspection or maintenance of the detection apparatus 19.

In the operating method, the maintenance apparatus 30 can carry out maintenance work by means of the actuator apparatus 40, wherein the maintenance work comprises repairing the conveyor line 10 and moving an object 70 that has been left behind and aligning and checking the detection apparatus 19. It is possible that data relating to the maintenance work carried out are stored in a database, wherein repeated maintenance work can be carried out automatically while taking the stored data into account. The maintenance apparatus 30 or its actuator apparatus 40 is remotely operable in particular by means of the remote control 50. Advantageously, a user can use the visualization apparatus 60 to obtain the geometric deviation as viewed in their field of view as a superimposition on the conveyor device 2. Thus, the user can remotely control the maintenance apparatus 30 specifically from outside in order to remove or repair the geometric deviation or to carry out maintenance work.

The operating method further provides generating the previously known information by means of an initial detection of the conveyor line 10 by means of the maintenance apparatus 30 when the conveyor line 10 is operationally ready to convey objects 70 and is in an initial state. To this extent, a proper original state or delivery condition of the conveyor line 10 can be recorded in order to be able to detect geometric deviations easily in the information obtained.

The maintenance apparatus 30 has various possible uses. In the operating method, objects 70 that have been left behind can be moved by means of the maintenance apparatus 30. Contaminants can be detected as geometric deviations by means of the maintenance apparatus 30 and in particular eliminated by cleaning by means of the maintenance apparatus 30.

For example, the maintenance apparatus 30 has a cleaning system with the sucker, which is configured to loosen contaminants on the conveyor line 10 and to suck the contaminants up. The cleaning system can be at least partly fastened to the actuator apparatus 40, for example in order to be able to move it in a targeted manner.

For example, a brush system and a scraper system of the cleaning system are provided in order to be able to detach contaminants by means of mechanical action with a brush or a scraper. The cleaning system has a collection system for the contaminants. In order to avoid dust, in particular as a result of the suction, the cleaning system has a filter. Waste air from the suction is discharged along the conveyor line 10 in such a way that as little dust as possible is produced. For example, waste air is discharged along the conveyor line and counter to the direction of movement of the maintenance apparatus 30.

The maintenance apparatus 30, the cleaning system here, has a pick-up system in order to pick up foreign bodies or objects 70 from the conveyor line and/or to deposit them in a receiving container of the pick-up system.

The detection apparatus 19, if it is adjusted, can be aligned by means of the maintenance apparatus 30. An opened enclosure 16, for example open safety apparatuses, can be detected by means of the maintenance apparatus 30 and these can be closed if appropriate or these can be reported. By means of the maintenance apparatus 30, damage to the enclosure 16 or to side walls can be detected and this can be repaired if necessary or this can be reported.

A development, wherein a maintenance cell or maintenance apparatus 30, for example one such as that from FIG. 1B, is introduced instead of a sorting cell or conveyor apparatus 20 in a sorter or a conveyor device 2, in particular a cross-belt sorter or cross-belt conveyor, is in particular illustrated and described. The maintenance cell is distinguished by the fact that above and below the sorter or the conveyor line 10, that is to say on the upper side 12 and the underside 14, the surroundings can be detected concomitantly by sensors, in particular photo-optically with cameras 32, 34. Remote operability of the maintenance cell and of the sorter is provided. It is possible for contaminants, objects 70 that have been left behind, defects, missing covers and the like to be detected in a manually operated process. A user or operator can wear the visualization apparatus 60 in the form of VR glasses and/or carry out observations of the maintenance cell from the computer. The maintenance cell or maintenance apparatus 30 can observe the conveyor line 10 in some sections and/or continuously when the conveyor device 2 is operated. It is possible to detect automatically whether and where an object 70 has jammed or other kinds of geometric deviations or a need for maintenance, for example on the detection apparatus, has arisen. This is particularly successful as a result of the automated target-current comparison by the method step “compare”. In other words, for example, it is possible to compare differences in surroundings, which can be successful on the basis of at least sectionally defined target surroundings of the conveyor line, in particular thanks to an enclosure 16. It is possible for the position of a “problem point” (jammed/left-behind object 70, geometric deviation, detection apparatus to be checked or adjusted, etc.) to be localized automatically, in order to be able to plan or carry out appropriate maintenance work or repairs.

A further embodiment of the development provides for the maintenance apparatus 30, for example one like that from FIG. 1C, in a conveyor device 2 to be moved by one or more conveyor apparatuses 20. The conveyor device 2 can be a conveyor belt and/or a roller conveyor. In principle, provision can be made for the maintenance device 30 to be moved along or conveyed like an object 70. Here, the maintenance apparatus 30 can concomitantly detect the surroundings by sensors at least above the conveyor line 10 of the conveyor device 2 or on the upper side 12, for example photo-optically with a camera 32. Here, too, remote operability and/or features can be provided, as explained in the previous paragraph.

A conveyor device 2 for conveying objects 70 is illustrated and described, having a circulating conveyor line 10 along which a multiplicity of conveyor apparatuses 20 and a maintenance apparatus 30 are movably guided in a row, wherein the conveyor apparatuses 20 are each designed to unload an object 70 resting thereon transversely with respect to the conveyor line 10, and wherein the maintenance apparatus 30 has a sensor system 31 for detecting the conveyor line 10 in order to obtain information relating to an upper side 12 and/or an underside 14 of the conveyor line 10.

A use of an in particular remotely controllable maintenance apparatus 30 is illustrated and described, having a sensor system 31 for detecting a conveyor line 10 of a conveyor device 2 designed for conveying objects 70 to obtain information relating to an upper side 12 and/or an underside 14 of the conveyor line 10 in an operation of the conveyor device 2 that moves the conveyor line 10 and the maintenance apparatus 30 at the same speed, wherein the conveyor device 2 has conveyor apparatuses 20 which are lined up in a row and are each designed to unload an object 70 resting thereon transversely with respect to the conveyor line 10.

### LIST OF REFERENCE SIGNS

2 Conveyor device
4 Conveying direction
10 Conveyor line
12 Upper side
14 Underside
16 Enclosure
17 Drive
18 Cover
19 Detection apparatus
20 Conveyor apparatus
22 Support
24 Coupling area
30 Maintenance apparatus
31 Sensor system
32 Camera (upper side)
34 Camera (underside)
36 Lighting apparatus
38 Location apparatus
40 Actuator apparatus
50 Remote control
60 Visualization apparatus
70 Object

1. A conveyor device for conveying objects, including a circulating conveyor line, along which a multiplicity of conveyor apparatuses and a maintenance apparatus are movably guided in a row, wherein:
the conveyor apparatuses are each designed to unload an object resting thereon transversely with respect to the conveyor line, and
the maintenance apparatus has a sensor system for detecting the conveyor line to obtain information relating to an upper side of the conveyor line.

2. The conveyor device according to claim 1, wherein the conveyor line has a rail for the conveyor and maintenance apparatus, and the sensor system has a camera on the upper side which is designed to detect a housing of the conveyor line and which provides at least one of an image and video signal as information.

3. The conveyor device according to claim 1, wherein the sensor system is provided for obtaining information about an under side of the conveyor line and comprises and/or a camera on the underside.

4. The conveyor device according to claim 1, wherein the maintenance apparatus is configured to detect cracks on the conveyor line.

5. The conveyor device according to claim 1, wherein the sensor system has a lighting apparatus for illuminating the conveyor line, and is directionally adjustable by motor.

6. The conveyor device according to claim 1, comprising a remote control for the remote operation of at least one of the conveyor line and the maintenance apparatus, wherein the remote control is designed to display the information, and wherein the remote control is designed for cable-free or cabled communication with the maintenance apparatus.

7. The conveyor device according to claim 1, wherein the maintenance apparatus has a collision protection system in order to detect a collision of the maintenance apparatus with at least one of objects and foreign bodies, wherein the collision protection system is configured to stop the conveyor device.

8. The conveyor device according to claim 1, wherein the maintenance apparatus is designed to at least one of monitor noise and monitor vibration and has at least one of an acoustic and vibration diagnostic system, or the maintenance apparatus designed to measure a clearance of the conveyor line.

9. The conveyor device according to claim 1, comprising a visualization apparatus which is designed to display the information.

10. The conveyor device according to claim 9, wherein the visualization apparatus is designed to display the information by means of at least one of an indicator and by means of augmented reality and/or virtual reality.

11. The conveyor device according to claim 1, comprising a location device for determining a position of the maintenance apparatus along the conveyor line.

12. The conveyor device according to claim 11, wherein the maintenance apparatus has a marking in order to optically mark a position of the maintenance apparatus.

13. The conveyor device according to claim 1, wherein the maintenance apparatus has an actuator apparatus for carrying out maintenance work on the conveyor line, wherein the actuator apparatus has a robot arm.

14. The conveyor device according to claim 13, wherein the robot arm is provided with the sensor system and/or a tool preferably for moving an object.

15. The conveyor device according to claim 1, wherein the maintenance apparatus has a cleaning system, which is configured to at least one of loosen contaminants on the conveyor line and suck up contaminants and has a collection system for the contaminants.

16. A method for operating the device according to claim 1, comprising:
moving the conveyor apparatus and the maintenance apparatus along the conveyor line, and
detecting the conveyor line by means of the maintenance apparatus in order to obtain the information.

17. The method for operating the device according to claim 16, wherein the maintenance apparatus is remotely operated and the information is at least one of displayed and stored.

18. The method according to claim 17, comprising:
comparing the information obtained with previously known information about the conveyor line, wherein:
the comparison is provided to check at least one of the function and alignment of a detection apparatus at least one of permanently installed on the conveyor line and to localize a geometric deviation in the conveyor line.

19. The method according to claim 1, wherein the maintenance apparatus carries out maintenance work,
the maintenance work comprises at least one of repairing the conveyor line and moving an object that at least one of has been left behind, aligning and checking the detection apparatus,
data relating to the maintenance work carried out are stored in a database, and
repeated maintenance work is carried out automatically while taking the stored data into account.
